(19) United States
(12) Patent Application Publication
(10) Pub. No.: US 2018/0011755 A1
(43) Pub. Date: Jan. 11, 2018

(54) INFORMATION PROCESSING APPARATUS FOR ANALYZING HARDWARE FAILURE AND INFORMATION PROCESSING SYSTEM THEREFOR

(71) Applicant: FUJITSU LIMITED, Kawasaki-shi (JP)

(72) Inventor: Hiroshi SAKURAI, Kawasaki (JP)

(73) Assignee: FUJITSU LIMITED, Kawasaki-shi (JP)

(21) Appl. No.: 15/712,903

(22) Filed: Sep. 22, 2017

Related U.S. Application Data
(63) Continuation of application No. PCT/JP2015/058972, filed on Mar. 24, 2015.

(51) Int. Cl. G06F 11/07; G06F 9/22; G06F 11/14; G06F 13/10

(52) U.S. Cl. CPC G06F 11/0727; G06F 11/141; G06F 9/22; G06F 13/10

(57) ABSTRACT

It is provided an information processing apparatus. The information processing apparatus includes memory, a processor configured to control a device, a circuit connected with the memory, the processor and the device and configured to store a first sequence which causes a failure of the device in a first storage area in the memory, store a second sequence which prevents the failure in a second storage area in the memory, determine whether a third sequence for controlling the device included in a packet output from the processor is the first sequence, coordinate the third sequence by using the second sequence when the third sequence is the first sequence, and generate a packet including the coordinated third sequence.

### CROSS-REFERENCE TO RELATED APPLICATION

This application is a continuation application of International Application PCT/JP2015/58972 filed on Mar. 24, 2015 and designated the U.S., the entire contents of which are incorporated herein by reference.

### FIELD

The embodiments discussed herein are related to an information processing apparatus used for preventing hardware failure and an information processing system therefor.

### BACKGROUND

Manufacturers of conventional information processing apparatuses provide information of defects of components and modifications of specifications etc. for the components of the information processing apparatuses such as Central Processing Units (CPUs) and peripheral devices, after the information processing apparatuses are implemented. The information provided by the manufacturers is referred to as errata information. The manufacturers use the errata information to take measures for preventing failures in advance. The measures include modifications of access sequences and write data in address spaces and Input/Output spaces, additions and deletions of access processes, modifications of access timings etc. for the apparatus. In addition, the manufacturers of the CPUs and peripheral devices provide information of conditions on which failures occur, information of the failures and information for preventing the failures.

The conventional information processing apparatuses use the information of the conditions on which the failures occur and the information of the failures to check whether sequences of user operations are the sequences which occur the failures (See patent document 1). And when the sequences of user operations in programs executed in the information processing apparatuses includes the sequences which occur the failures, the programs are modified with reference to the sequences which occur the failures. The modifications of the programs include additions of accesses to the address spaces and the I/O spaces, modifications and/or deletions of write data and modifications of the access timings. Thus, the information processing apparatuses execute the modified programs to prevent the failures.

The following patent documents describe conventional techniques related to the techniques described herein.

### [Patent Document]

[Patent document 1] Japanese Laid-open Patent Publication No. 2004-78626

### SUMMARY

According to one embodiment, it is provided an information processing apparatus. The information processing apparatus includes memory, a processor configured to control a device, a circuit connected with the memory, the processor and the device and configured to store a first sequence which causes a failure of the device in a first storage area in the memory, store a second sequence which prevents the failure in a second storage area in the memory, determine whether a third sequence for controlling the device included in a packet output from the processor is the first sequence, coordinate the third sequence by using the second sequence when the third sequence is the first sequence, and generate a packet including the coordinated third sequence.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a configuration of an information processing apparatus according to an embodiment;

FIG. 2 is a diagram illustrating an example of a configuration of a packet processing circuit according to an embodiment;

FIG. 3 is a diagram illustrating an example of functional blocks of an information processing apparatus according to an embodiment;

FIG. 4 is a diagram illustrating an example of information stored in memory according to an embodiment;

FIG. 5 is a diagram illustrating an another example of information stored in memory according to an embodiment;

FIG. 6 is a diagram illustrating an example of a configuration of a packet monitoring circuit according to an embodiment;

FIG. 7 is a diagram illustrating an example of a format of a packet processed by a packet processing circuit according to an embodiment;

FIG. 8 is a diagram illustrating an example of a configuration of an access generating circuit according to an embodiment;

FIG. 9 is a diagram illustrating an example of a configuration of a buffer according to an embodiment;

FIG. 10A is a diagram illustrating an example of a truth table used by a control code decoder according to an embodiment;

FIG. 10B is a diagram illustrating an example of a truth table used by a multiplexer according to an embodiment;

FIG. 11 is a diagram illustrating an example of a flowchart of processes executed by a CPU #A according to an embodiment;

FIG. 12 is a diagram illustrating a time chart when an information processing apparatus according to an embodiment executes the processes in the flowchart in FIG. 11; and

FIG. 13 is a diagram illustrating an example of a configuration of an information processing apparatus according to a variation.

### DESCRIPTION OF EMBODIMENTS

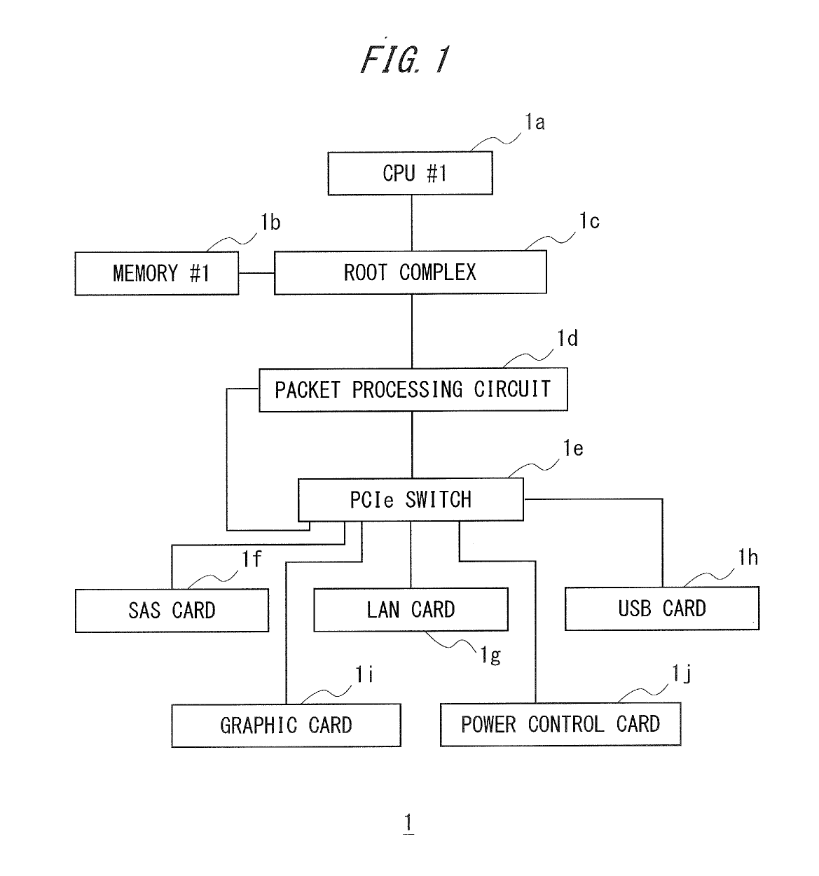

When a program is modified in order to prevent a failure, various programs used for the OS driver, the firmware and the applications etc. are also modified. In this case, an analysis of how to modify the programs is involved. In addition, when the OS driver and the firmware which are commonly used by various applications to be modified is modified, checks on the operations between the modified OS driver and each application and between the modified firmware and each application are also involved. Thus, the workload of the analysis and the checks etc. can be an obstacle to swiftly perform processes for preventing the failure. First, an information processing apparatus according to an embodiment is described below with reference to the drawings. An information processing apparatus 1 illustrated in FIG. 1 is employed in the present embodiment. As an example, the information processing apparatus 1 controls peripheral devices according to the PCI Express (Registered Trademark) standard. As illustrated in FIG. 1, the information processing apparatus 1 includes a CPU #1 1a, memory #1 1b, a root complex 1c, a packet processing circuit 1d, a PCIe switch 1e, a Serial Attached SCSI (SAS) card 1f, a Local Area Network (LAN) card 1g, a Universal Serial Bus (USB) card 1h, a graphic card 1i, a power control card 1j etc.

The CPU #1 1a controls processes for reading and writing data for the SAS card 1f, the LAN card 1g, the USB card 1h, the graphic card 1i and the power control card 1j. The memory #1 1b stores data read and written by the CPU #1 la. The root complex 1c functions as an interface for connecting the CPU #1 1a with the SAS card 1f, the LAN card 1g, the USB card 1h, the graphic card 1i and the power control card 1j. In addition, the root complex 1c controls accesses to the memory #1 1b.

The packet processing circuit 1d is a circuit for processing packets transmitted between the CPU #1 1a and the SAS card 1f, between the CPU #1 1a and the LAN card 1g, between the CPU #1 1a and the USB card 1h, between the CPU #1 1a and the graphic card 1i and between the CPU #1 1a and the power control card 1j. As illustrated in FIG. 1, the packet processing circuit 1d is connected with the PCIe switch 1e in a manner that the packet processing circuit 1d is under the control of the PCIe switch 1e, similar to the other cards. Therefore, when the packet processing circuit 1d adds a sequence to a card in the information processing apparatus 1, the transmission of the packet to the card can be processed as the sequence of the packet processing circuit 1d. The details of processes executed by the packet processing circuit 1d are described later.

The PCIe switch 1e controls the connections and the packet transmissions between the packet processing circuit 1d and the SAS card 1f, between the packet processing circuit 1d and the LAN card 1g, between the packet processing circuit 1d and the USB card 1h, between the packet processing circuit 1d and the graphic card 1i and between the packet processing circuit 1d and the power control card 1j. Since the SAS card 1f, the LAN card 1g, the USB card 1h, the graphic card 1i and the power control card 1j are conventional cards, the descriptions of the cards are omitted here.

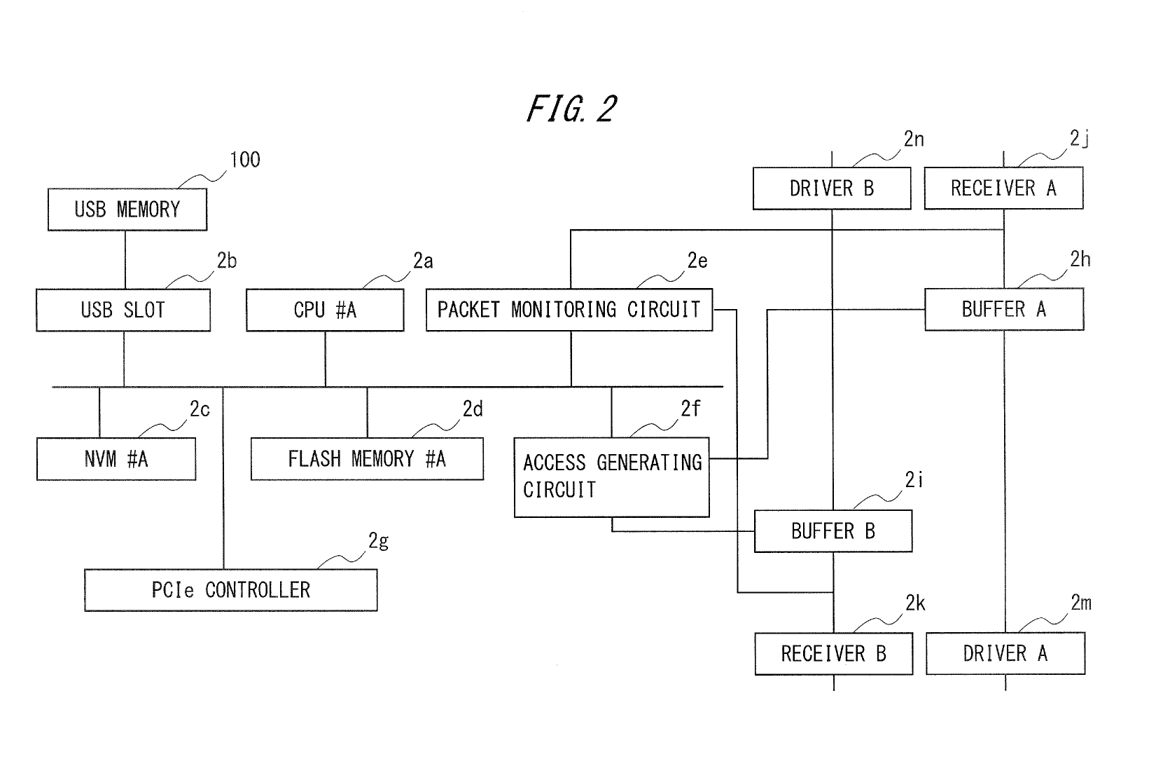

FIG. 2 schematically illustrates a configuration of the packet processing circuit 1d. As illustrated in FIG. 2, the packet processing circuit 1d includes a CPU #A 2a, a USB slot 2b, a Non-volatile Memory (NVM) #A 2c, a flash memory #A 2d, a packet monitoring circuit 2e, an access generating circuit 2f, a PCIe controller 2g, a buffer A 2h, a buffer B 2i, a receiver A 2j, a receiver B 2k, a driver A 2m and a driver B 2n. The CPU #A 2a controls processes executed by the packet processing circuit 1d as described below.

The USB slot 2b accepts USB memory 100 connected from outside of the information processing apparatus 1. It is noted that the USB memory 100 stores information of triggers of processes which may occur failures and information of processes which can be executed in place of the processes which may occur the failures. It is also noted that the information of the triggers of the processes which may occur the failures is information of sequences which may occur hardware failures in the information processing apparatus 1 as described below. The information acquired from the USB memory 100 is stored in the NVM #A 2c.

The flash memory #A 2d stores programs for initializing the CPU #A 2a, the packet monitoring circuit 2e and the access generating circuit 2f which are executed at the time of the power-on of the information processing apparatus 1 and PCI configuration information of the packet processing circuit 1d. The packet monitoring circuit 2e detects sequence data included in packets input into the packet processing circuit 1d and compares the detected data. The access generating circuit 2f uses sequence data stored in the NVM #A 2c to generate packets including sequence data for preventing failures.

The buffer A 2h and the buffer B 2i retains packets generated by the access generating circuit 2f. It is noted that the buffer A 2h and the buffer B 2i are examples of storing units. In addition, the buffer A 2h and the buffer B 2i purges or outputs packets according to instructions from the CPU #A 2a. The driver A 2m and the driver B 2n outputs packets from the buffer A 2h and the buffer B 2i to the PCIe bus which connects the packet processing circuit 1d with each card as described above. The receiver A 2j receives packets output from the CPU #1 1a and outputs the received packets to the packet monitoring circuit 2e and the buffer A 2h. In addition, the receiver B 2k receives packets output from each card as described above and outputs the received packets to the packet monitoring circuit 2e and the buffer B 2i.

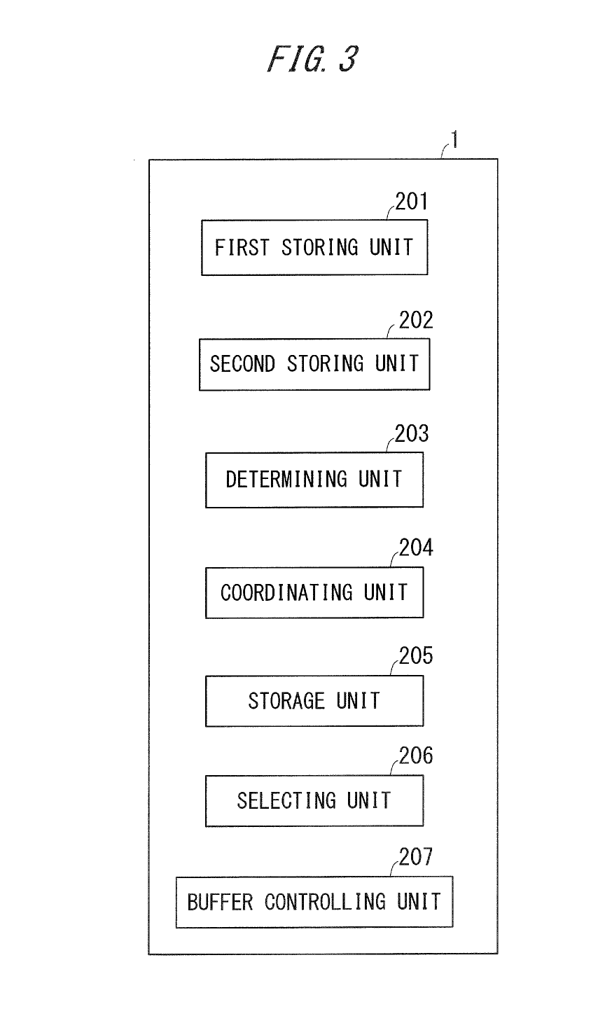

FIG. 3 schematically illustrates an example of functional blocks of the information processing apparatus 1 according to the present embodiment. In the present embodiment, when the CPU #A 2a of the packet processing circuit 1d deploys programs stored in the flash memory #A 2d on memory (not illustrated) and executes the deployed programs, the information processing apparatus 1 functions as a first storing unit 201, a second storing unit 202, a determining unit 203, a coordinating unit 204, a storage unit 205, a selecting unit 206 and a buffer controlling unit 207.

The first storing unit 201 stores sequences in advance which may occur failures of the hardware including the SAS card 1f, the LAN card 1g, the USB card 1h, the graphic card 1i and the power control card 1j. The second storing unit 202 stores sequences for preventing the failures. In addition, the determining unit 203 determines whether sequences for controlling the hardware output from the CPU #1 1a are sequences stored in the first storing unit 201. When the determining unit 203 determines that a sequence output from the CPU 1a is one of the sequences stored in the first storing unit 201, the coordinating unit 204 uses a sequence stored in the second storing unit 202 to coordinate the sequence output from the CPU #1 1a.

The storage unit 205 stores sequences output from the CPU #1 1a for controlling the hardware in the information processing apparatus 1. The selecting unit 206 selects sequences from among sequences which have been delayed for several numbers of sequences via the storage unit 205 and sequences acquired from the second storing unit 202 corresponding to sequences stored in the first storing unit 201. The buffer controlling unit 207 controls discarding of sequences stored in the storage unit 205 and selecting of sequences by the selecting unit 206.

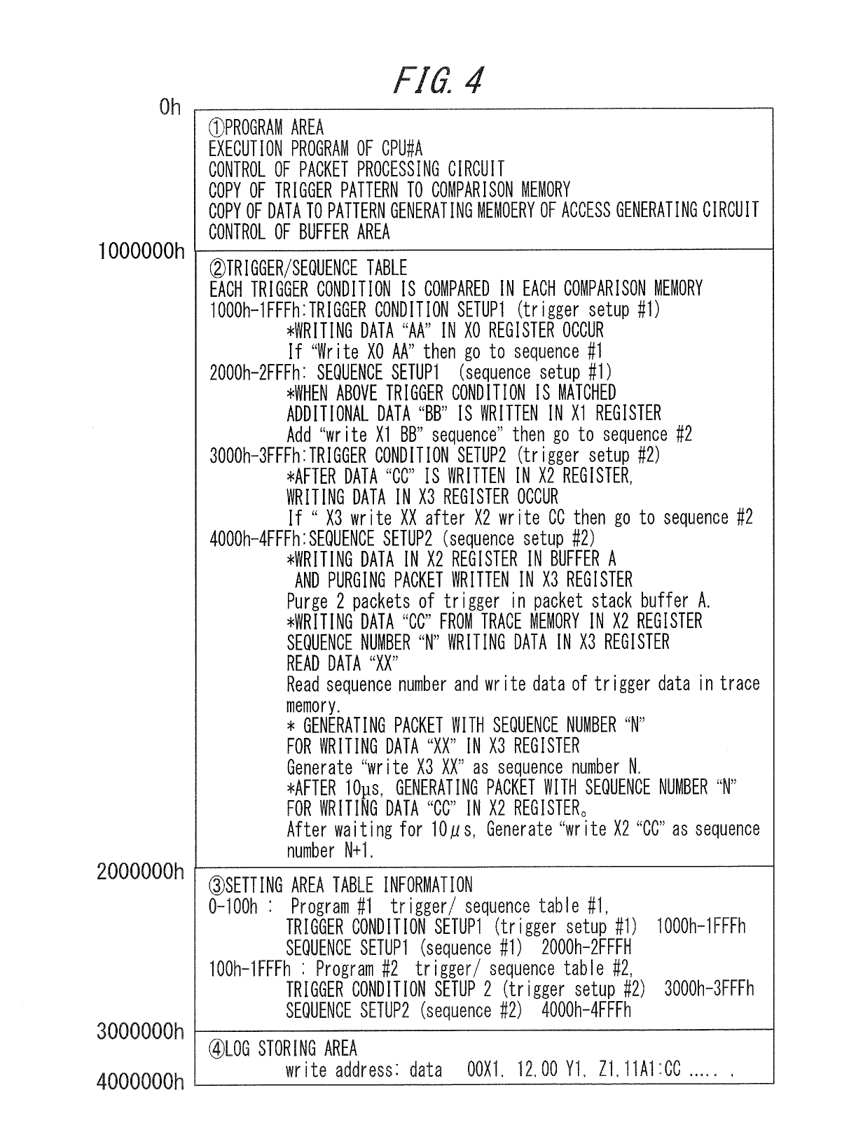

FIG. 4 illustrates an example of information stored in the NVM #A 2c in the present embodiment. As illustrated in FIG. 4, the area ranging from the address 0h to the address 1000000h is a program area. The program area stores programs executed by the CPU #A 2a, programs for controlling the packet processing circuit 1d, programs for executing processes including copying of trigger patterns of processes which may occur the failures as described above, copying of data to a pattern generating memory of the access generating circuit 2f and controlling of the buffer areas.

In addition, the area ranging from the address 1000001h to 2000000h is an area in which information of trigger conditions and sequences executed when the trigger conditions are satisfied is stored. It is noted that the trigger conditions are conditions for determining whether a sequence which may occur a failure in a card in the information processing apparatus 1 is output from the CPU #1 1a. In addition, the information of the sequences is sequence data executed for preventing the failure. FIG. 4 illustrates an example of information of trigger conditions and sequences regarding sequences output from the CPU #1 1a to the USB card 1h. Further, the area ranging from the address 2000001h to the address 3000000h is an area for storing information indicating areas in which the information of the trigger conditions and the sequences is stored. Moreover, the area ranging from the address 3000001h to the address 4000000h is an area for storing histories of data written when the sequences are executed.

As illustrated in FIG. 4, when the CPU #1 1a outputs a sequence for writing data “AA” in an X0 register to the USB card 1h, the trigger condition described in the section “trigger condition setup 1 (trigger setup #1)” is satisfied in the packet processing circuit 1d. As a result, a sequence for writing data “BB” in an X1 register is added to the USB card 1h according to the sequence described in the section “sequence setup 1 (sequence setup #1)”.

In another example, after the CPU #1 1a outputs a sequence for writing data “CC” in the X2 register to the USB card 1h, another sequence for writing data “XX” (XX is an arbitrary value) in the X3 register is output to the USB card 1h. In this example, the trigger condition described in the section “trigger condition setup 2 (sequence setup #2)” is satisfied in the packet processing circuit 1d. And the packet processing circuit 1d changes according to the sequence described in the section “trigger condition setup 2 (sequence setup #2)” the order of the sequence for writing data “CC” in the X2 register and the sequence for writing data “XX” in the X3 register. In addition, when waiting time for 10 μsec elapses after the sequence for writing data “CC” in the X2 register is generated, the sequence for writing data “XX” in the X3 register is generated.

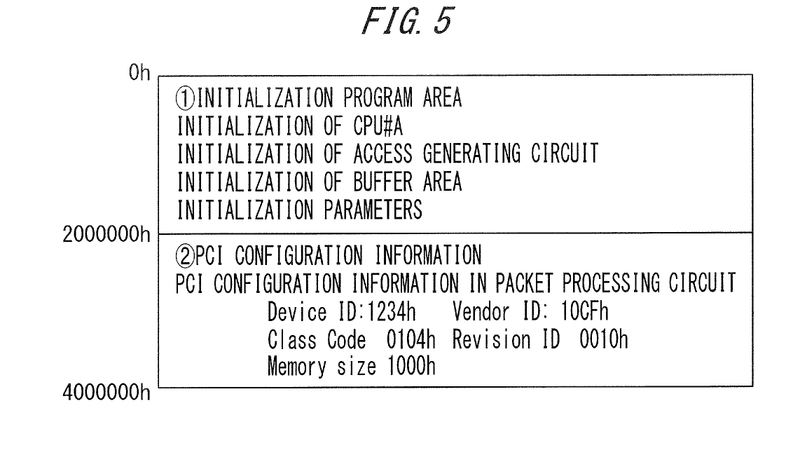

FIG. 5 illustrates an example of information stored in the flash memory #A 2d in the present embodiment. As illustrated in FIG. 5, the area ranging from the address Oh to the address 2000000h in the flash memory #A 2d is an area for storing initialization programs executed by the CPU #A 2d. The data stored in the area includes, for example, a program for initializing the CPU #A 2a, a program for initializing the access generating circuit 2f, a program for initializing buffer areas and parameters used in the initialization programs. The area ranging from the address 2000001h to the address 4000000h is an area for storing PCI configuration information of the packet processing circuit 1d.

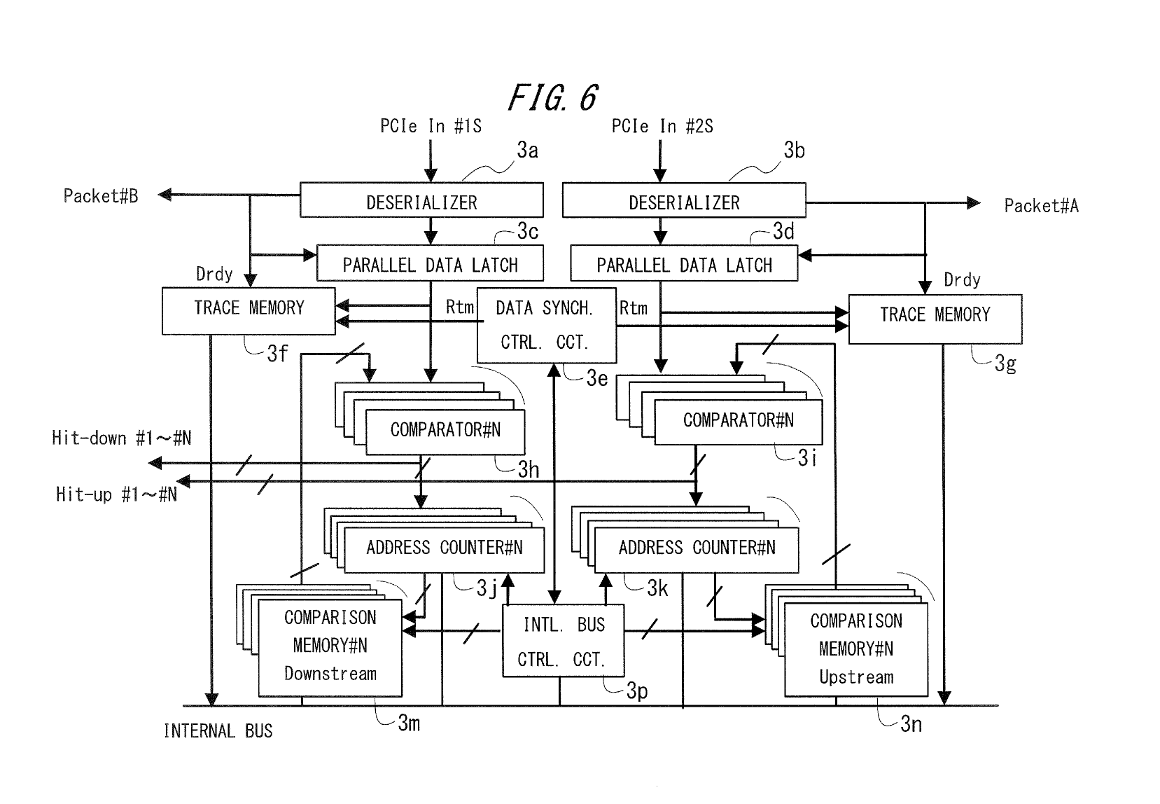

FIG. 6 illustrates an example of a configuration of the packet monitoring circuit 2e. As illustrated in FIG. 6, the packet monitoring circuit 2e includes deserializers 3a, 3b, parallel data latches 3c, 3d, a data synchronization controlling circuit 3e, trace memory 3f, 3g, N (N is an arbitrary natural number) comparators #N 3h, 3i, N address counters #N 3j, 3k, N comparison memory #N 3m, 3n and an internal bus controlling circuit 3p. It is noted that one of the comparison memory #N 3m, 3n is an example of a first storage unit. It is noted that each of the comparators #N 3h, 3i is an example of a determining unit. It is noted that each of the address counters #N 3j, 3k is an example of an indicating unit. It is also noted that the comparators #N 3h, 3i, the address counters #N 3j, 3k and the comparison memory #N 3m, 3n are paired with each other.

The deserializers 3a, 3b acquire packets input into the packet processing circuit 1d and convert the acquired packets from serial data to parallel data. In addition, the deserializers 3a, 3b output a signal (Drdy: Data Ready) which indicates that the conversion of the acquired packets from serial data to parallel data is completed. Further, the deserializers 3a, 3b also output a signal (Packet #A, Packet #B) which indicates that the deserializers 3a, 3b acquire the packets.

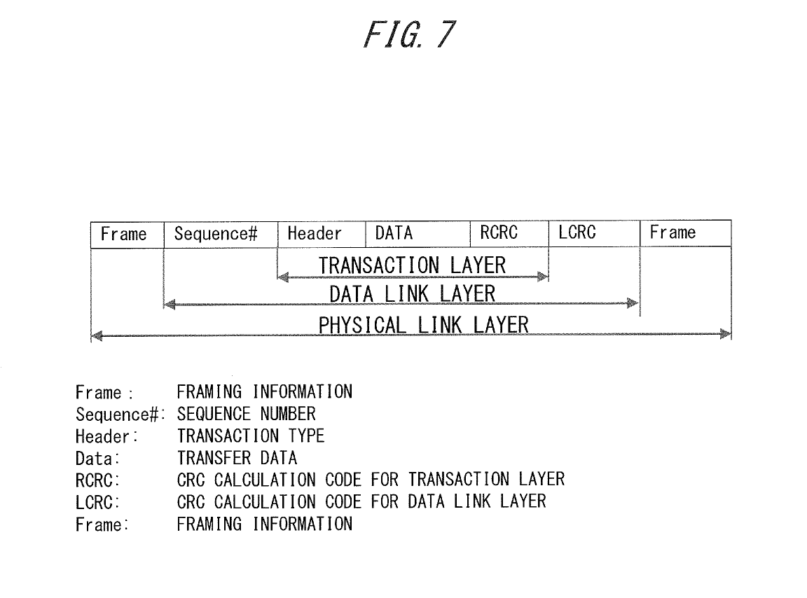

The parallel data latches 3c, 3d latch the parallel data output from the deserializers 3a, 3b according to the Drdy signals. In addition, the parallel data latches 3c, 3d clip information from the packets and process the clipped information. The information clipped by the parallel data latches 3c, 3d is used for the comparison processes executed by the comparators #N 3h, 3i. FIG. 7 illustrates an example of a format of a packet processed by the parallel data latches 3c, 3d. As illustrated in FIG. 7, the packet can be divided into a transaction layer, a data link layer and a physical link layer. Further, the packet includes framing information (Frame), sequence information (Sequence#), transaction type (Header), transferred data (Data), a Cyclic Redundancy Check (CRC) calculation code for the transaction layer (RCRC: Read Cyclic Redundancy Check). RCR calculation code for the data link layer (LCRC: Link Cyclic Redundancy Check) and the framing information (Frame).

The trace memory 3f, 3g stores the parallel data latched by the parallel data latches 3c, 3d. The processes for writing data in the trace memory 3f, 3g are executed in synchronization with the Drdy signals. In addition, the processes for reading data from the trace memory 3f, 3g are executed in synchronization with the Rtm signals output from the data synchronization controlling circuit 3e. the data synchronization controlling circuit 3e controls the synchronization of data access from the internal bus according to the control by the internal bus controlling circuit 3p. When the data synchronization controlling circuit 3e receives via the internal bus controlling circuit 3p a signal for requesting a process of reading data from the internal bus, the data synchronization controlling circuit 3e outputs an Rtm signal.

The comparison memory #N 3m, 3n stores trigger conditions stored in the NVM #A 2c . Each of the comparison memory #N 3m, 3n stores a trigger condition for determining whether one or more sequences occur. In addition, the comparison memory #N 3m, 3n receives data of the trigger condition from the internal bus controlling circuit 3p.

The comparators #N 3h, 3i compare trigger conditions acquired from the comparison memory #N 3m, 3n with data input from the parallel data latches 3c, 3d. Specifically, the comparators #N 3h, 3i compare sequences included in data received from the parallel data latches 3c, 3d with sequences included in trigger conditions acquired from the comparison memory #N 3m, 3n to determine whether the sequences match to each other.

The comparator #N 3h compares packets in the downstream input into the packet processing circuit 1d. In addition, the comparator #N 3i compares packets in the upstream input into the packet processing circuit 1d. When the comparators #N 3h, 3i determine based on the comparisons that the sequences as described above match to each other, the comparator #N 3h outputs a signal Hit-down#N and the comparator #N 3i outputs a signal Hit-up#N. In addition, the comparator #N 3h outputs a signal Upd#N to the address counter #N 3j and the comparator #N 3i outputs a signal Upu#N to the address counter #N 3k. Signals Upd#N and Upu#N are signals indicating that the trigger conditions are satisfied.

The trigger conditions stored in the NVM #A 2c are described here. For example, when the comparator #1 of the comparator #N 3h is used to determine whether an instruction B occurs subsequent to an instruction A, the trigger condition stored in the comparison memory #1 of the comparison memory #N 3m includes a first condition to determine that a sequence for executing the instruction A occurs and a second condition to determine that a sequence for executing the instruction B occurs. In the present embodiment, the comparator #1 which is paired with the comparison memory #1 used the first condition and the second condition in this order to executed the comparison process.

In an example, when a signal Upd#N output from the comparator #N 3h is input into the address counter #N 3j, the address counter #N 3j increments the counter value by 1. The counter value after the increment by the address counter #N 3j is output to the comparison memory #N 3m. The counter value of the address counter #N 3j is the address of the comparison memory #N 3m. For example, the “a”th (a is a natural number) condition included in a trigger condition is stored in the address “a” in the comparison memory #N 3m. In this case, the comparison memory #N 3m outputs the “a”th condition stored in the address “a” to the comparator #N 3h when the counter value input from the address counter #N 3j into the comparison memory #N 3m is “a”.

In the above example, the initial value of the counter value of the address counter #1 of the address counters #N 3j is set to 1. In addition, the first condition and the second condition are stored in the comparison memory #1 of the comparison memory #N 3m. And the comparator #1 of the comparator #N 3h determines that the first condition is matched. As a result, the comparator #1 of the comparator #N 3h outputs a signal Upd#1 and the address counter #1 of the address counter #N 3j increments the counter value to 2 according the signal Upd#1. The address counter #1 of the address counter #N 3j outputs the counter value “2” to the comparison memory #1 of the comparison memory #N 3m. The comparison memory #1 of the comparison memory #N 3m reads the second condition according to the counter value “2” and outputs the data of the second condition to the comparator #1 of the comparator #N 3h.

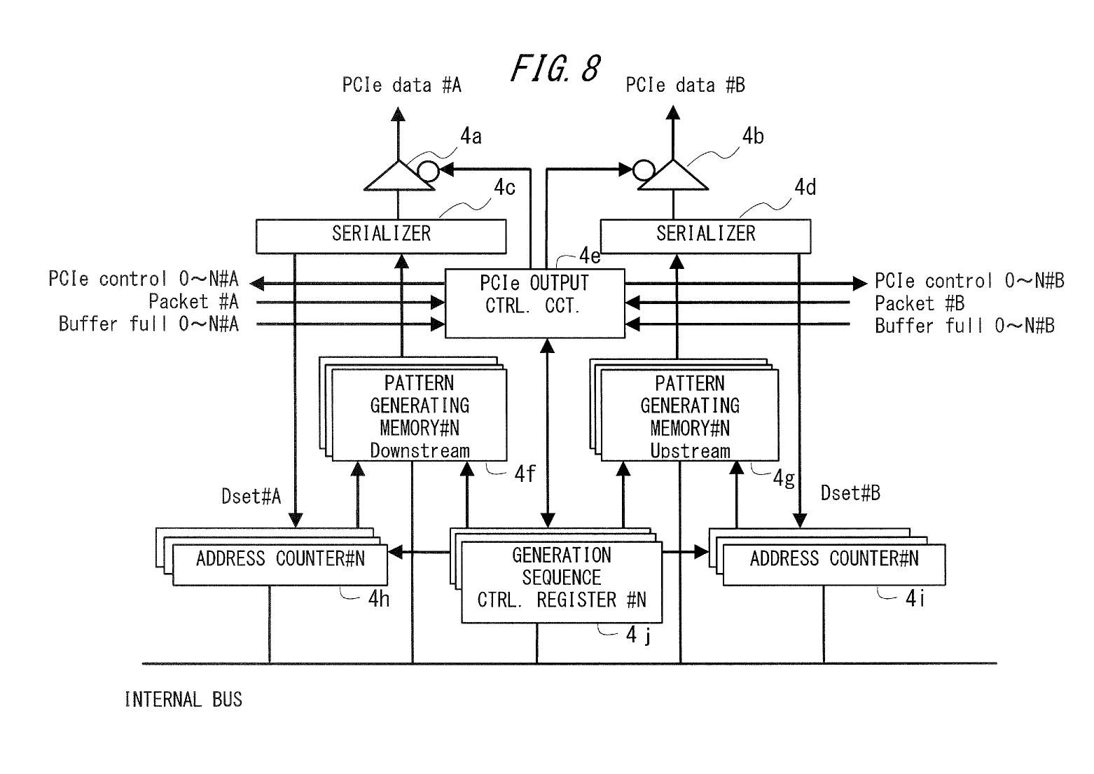

FIG. 8 illustrates an example of a configuration of the access generating circuit 2f. As illustrated in FIG. 8, the access generating circuit 2f includes gates 4a, 4b, serializers 4c, 4d a PCIe output controlling circuit 4e, N (N is an arbitrary natural number) pattern generating memory #N 4f, 4g, N address counters #N 4h, 4i and N generation sequence controlling register #N 4j. It is noted that each of the pattern generating memory #N 4f, 4g is an example of a second storing unit. It is also noted that each of the generation sequence controlling register #N 4j is an example of a coordinating unit.

The pattern generating memory #N 4f, 4g stores sequences executed when the trigger conditions stored in the NVM #A 2C are satisfied. The pattern generating memory #N 4f, 4g is paired with the comparison memory #N 3m, 3n. Therefore, a sequence executed when trigger conditions stored in the comparison memory #N 3m, 3n are satisfied is stored in the pattern generating memory #N 4f, 4g. The pattern generating memory #N 4f, 4g forms data used in the sequence into a PCIe packet by combining a transaction layer, a data link layer and a physical layer. And the formed PCIe packet is written back into the pattern generating memory #N 4f, 4g. The written PCIe packet is output to the serializers 4c, 4d.

The generation sequence controlling register #N 4j controls each unit in the access generating circuit 2f according to the instructions input into the generation sequence controlling register #N 4j via the internal bus from the CPU #A 2a of the packet processing circuit 1d. The PCIe output controlling circuit 4e controls the operation timings of the gates 4a, 4b to output a signal PCIe control N#A for controlling a purging process of the buffer A 2h and a signal PCIe control N#B for controlling a purging process of the buffer B 2i. The serializers 4c, 4d converts the parallel data of the sequences input into the serializers 4c, 4d from the pattern generating memory #N 4f, 4g into serial data. And the serializers 4c, 4d output the converted serial data to the gates 4a, 4b, respectively.

In addition, there may be a case in which the sequences stored in the pattern generating memory #N 4f, 4g include a plurality of processing instructions. For example, when a sequence for executing a processing instruction B subsequent to a processing instruction A is stored in each of the pattern generating memory #N 4f, 4g, each of the pattern generating memory #N 4f, 4g sequentially outputs the processing instructions A and B to the serializers 4c, 4d according to signals which specify addresses in the pattern generating memory #N 4f, 4g and are input from the address counters #N 4h, 4i.

When the serializer 4c outputs to the gate 4a data processed in a sequence input from the pattern generating memory #N 4f, the serializer 4c outputs a timing signal Dset#A to the address counter #N 4h. When the signal Dset#A is input from the serializer 4c into the address counter #N 4h, the address counter #N 4h increments the counter value by 1. The counter value after the increment by the address counter #N 4h is output to the pattern generating memory #N 4f. The counter value of the address counter #N 4h is address in the pattern generating memory #N 4f. For example, there may be a case in which the “a”th processing instruction is stored in the address “a” in the pattern generating memory #N 4f. In this case, the pattern generating memory #N 4f outputs the “a”th processing instruction stored in the address “a” to the serializer 4c, when the counter value input from the address counter #N 4h is “a”.

In an example, the initial value of the counter value of the address counter #1 of the address counter #N 4h is set to 1. In addition, the first processing instruction and the second processing instruction of a sequence are stored in the pattern generating memory #1 of the pattern generating memory #N 4f. In this example, the pattern generating memory #1 of the pattern generating memory #N 4f outputs the data of the first processing instruction to the serializer 4c according to the control by the generation sequence controlling register #N 4j.

When the serializer 4c outputs the data of the first processing instruction to the gate 4a, the serializer 4c outputs the signal Dset#A to the address counter #1 of the address counter #N 4h. When the signal Dset#A is input into the address counter #1 of the address counter #N 4h, the address counter #1 of the address counter #N 4h increments the counter value to 2. And the address counter #1 of the address counter #N 4h outputs the counter value 2 to the pattern generating memory #1 of the pattern generating memory #N 4f. And the pattern generating memory #1 of the pattern generating memory #N 4f outputs the data of the second processing instructions to the serializer 4c according to the counter value 2.

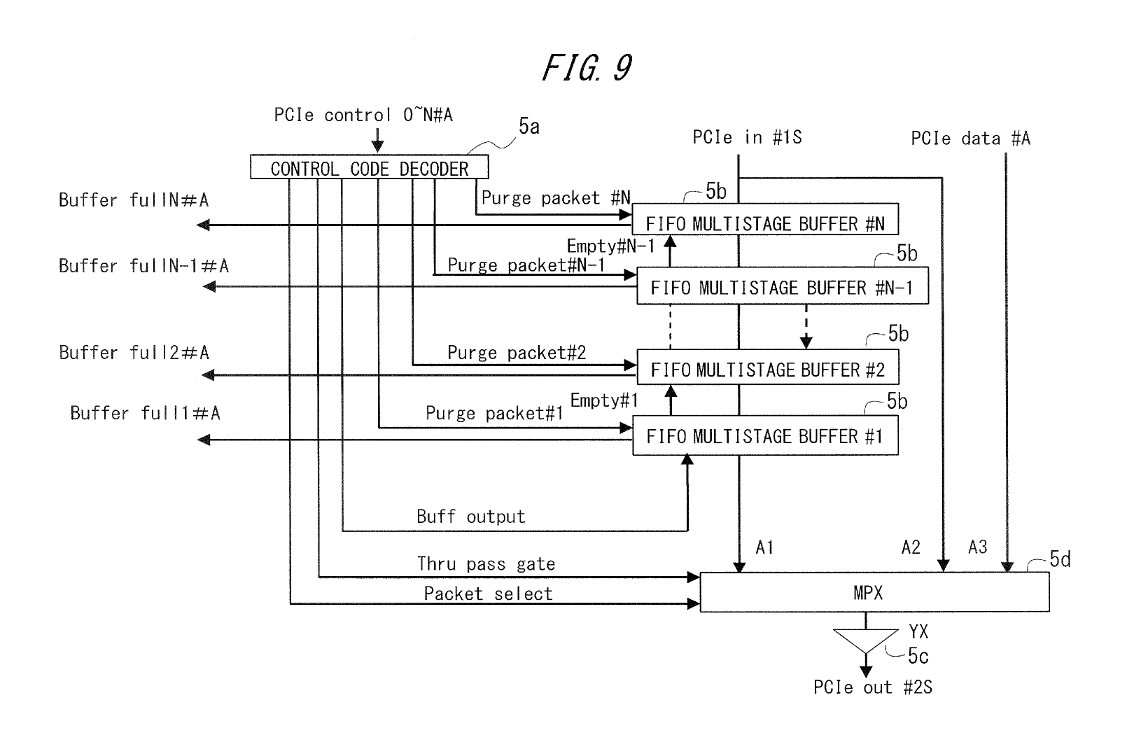

FIG. 9 illustrates an example of a configuration of the buffer A 2h. As illustrated in FIG. 9, the buffer A 2h includes a control code decoder 5a, M (M is an arbitrary natural number) First-In First-Out (FIFO) multistage buffers #M 5b, a driver 5c and a multiplexer 5D. It is noted that the control code decoder 5a is an example of a buffer controlling unit. It is also noted that the multiplexer 5d is an example of a selecting unit.

The control code decoder 5a decode buffer controlling signals PCIe control 0#A to N#A output from the access generating circuit 2f into control signals for each unit in the buffer A 2h. The FIFO multistage buffer #M 5b stores signals PCIe in #1S which are output from the CPU #1 1a and input into the packet processing circuit 1d via the root complex 1c. The FIFO multistage buffer #M 5b stores the signals PCIe in #1S on a packet basis.

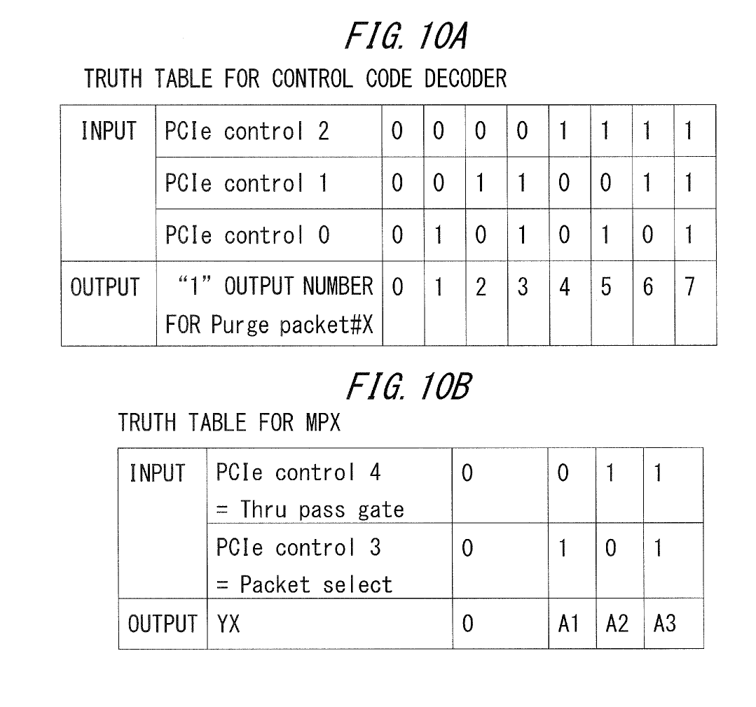

The control code decoder 5a outputs instructions for purging packets stored in the FIFO multistage buffer #M 5b according to the instructions from the CPU #A 2a. The control code decoder 5a uses a truth table as illustrated in FIG. 10A and signals including Thru pass gate signals and Packet select signals to control processes for outputting packets from PCIe in #1S/#2S.

FIG. 10A illustrates an example of the truth table used by the control code decoder 5a for purging packets stored in the FIFO multistage buffer #M 5b. FIG. 10B illustrates an example of the truth table used by the control code decoder 5a for controlling the process for outputting packets from the multiplexer 5d. For example, the control code decoder 5a executes processes for purging the FIFO multistage buffers #1 to #7 of the FIFO multistage buffer #M 5b according to the combinations of the signals PCIe control 0#A to 2#A indicating “0” or “1” which are input from the access generating circuit 2f. When the signals PCIe control 0#A to 2#A indicate “0”, the control code decoder 5a does not execute the process for purging the FIFO multistage buffer #M 5b.

In addition, the control code decoder 5a controls the multiplexer 5d to output packets according to the combinations of the signals PCIe control 3#A and 4#A indicating “0” or “1” which are input from the access generating circuit 2f. As illustrated in the truth table in FIG. 10B, the multiplexer 5d outputs packets input from one of the inputs A1 to A3 to the driver 5c according to the output control by the control code decoder 5a. When the signals PCIe control 3#A and 4#A indicate “0”, the control code decoder 5a controls the multiplexer 5d not to output a packet to the driver 5c.

In the present embodiment, when the multiplexer 5d selects the input A1 or the input A3 according to the control by the control code decoder 5a, delaying of sequences output from the CPU #1 1a, discarding of the sequences, changing of the order of the sequences, and/or inserting another sequence between the sequences can be achieved. For example, when a packet including a sequence output from the CPU #1 1a is stored in the FIFO multistage buffer #M 5b, a delay occurs due to the buffering. In this case, when the control code decoder 5a controls the multiplexer 5d to select the input A2, the packet including the sequence output from the CPU #1 1a can be output from the packet processing circuit 1d without the delay which occurs when the packet is stored in the FIFO multistage buffer #M 5b.

The FIFO multistage buffer #M 5b is a buffer for executing the FIFO processes of packets on a packet basis. When the buffer becomes full, the FIFO multistage buffer #M 5b outputs a buffer full signal. In addition, an empty signal indicates that the FIFO multistage buffer is empty and data output from the preceding stage can be stored in the buffer. A signal Purge packet #N is a signal for clearing the buffers in the FIFO multistage buffer #M 5b and a signal for instructing a process for deleting the packet to be purged.

The driver 5c outputs packets to the PCIe bus according to instructions from the PCIe output controlling circuit 4e of the access generating circuit 2f. The multiplexer 5d outputs packets input from the input A1, A2 or A3 to the driver 5c or does not output the packets to the driver 5c according to the control by the control code decoder 5a using the truth table in FIG. 10B.

In the present embodiment, when the packet processing circuit 1d deletes a sequence, the FIFO multistage buffer (s) which stores a packet including the sequence is purged according to the control by the CPU #A 2a, the PCIe output controlling circuit 4e and the generation sequence controlling register #N 4j. When the packet processing circuit 1d executes a process for changing the order of sequences, the FIFO multistage buffer (s) which stores packets including the sequences is purged. In addition, a signal PCIe data #A is generated according to the changed order of sequences. The generated signal is input into the input A3 and output via the driver 5c to the PCIe switch 1e.

Moreover, when the packet processing circuit 1d adds a sequence, processes for outputting packets from the buffer A 2h are suspended according to the control by the CPU #A 2a, the PCIe output controlling circuit 4e and the generation sequence controlling register #N 4j. In addition, an additional sequence is output via the PCIe controller 2g to the PCIe switch 1e. And when the processes for outputting the packets from the buffer A 2h are resumed, the sequences stored in the buffer A 2h can be output subsequent to the additional sequence from the packet processing circuit 1d. The additional sequence can be input into the buffer A 2h in a case. In this case, the packet processing circuit 1d uses a function referred to as a representation response to coordinate the order of the existing sequences and the additional sequence. In addition, the multiplexer 5d selects the input A3 according to the control by the control code decoder 5a. As a result, the additional sequence is output to the PCIe switch 1e.

Since the buffer B 2i employs a configuration similar to the buffer A 2h, the illustrations and descriptions of the buffer B 2i are omitted here. In the configuration in FIG. 9, the configuration of the buffer B 2i is different from the configuration of the buffer A 2h in that a signal PCIe control #B is input into the control code decoder, a signal PCIe in #2S is input into the FIFO multistage buffer #M 5b and a signal PCIe data #B is input into the multiplexer. Further, in the configuration in FIG. 9, the configuration of the buffer B 2i is different from the configuration of the buffer A 2h in that a signal Buffer full1 #B is output from the FIFO multistage buffer #1.

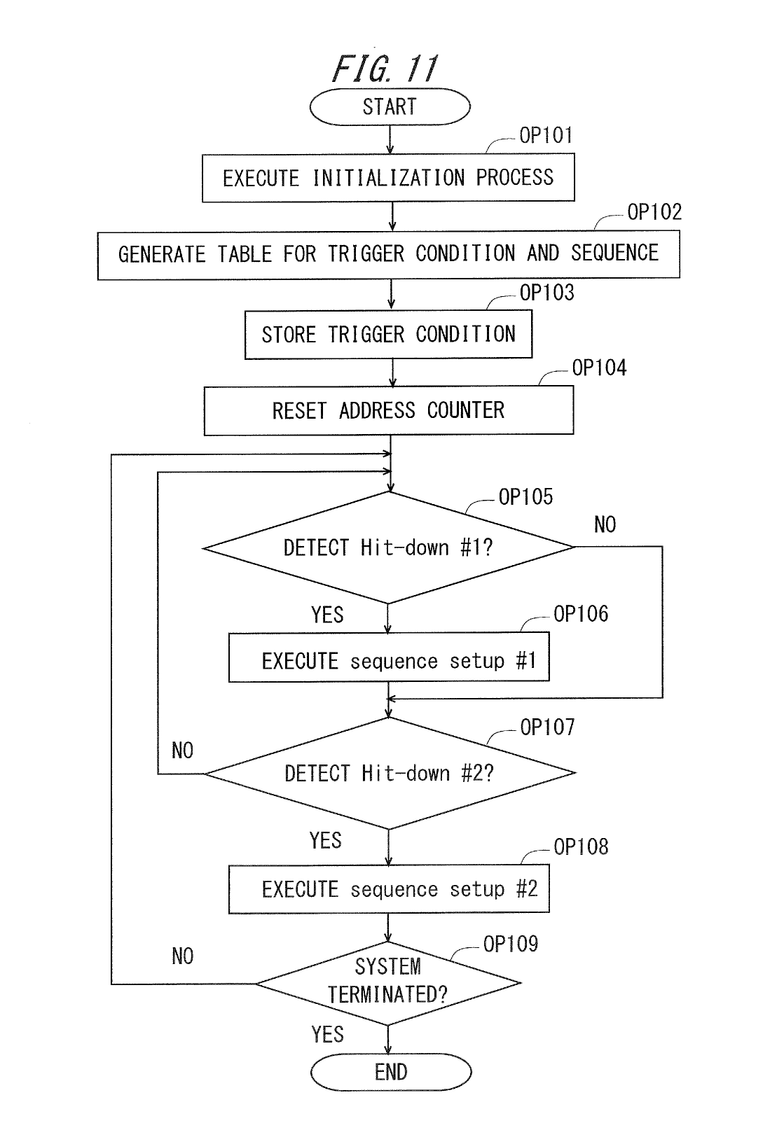

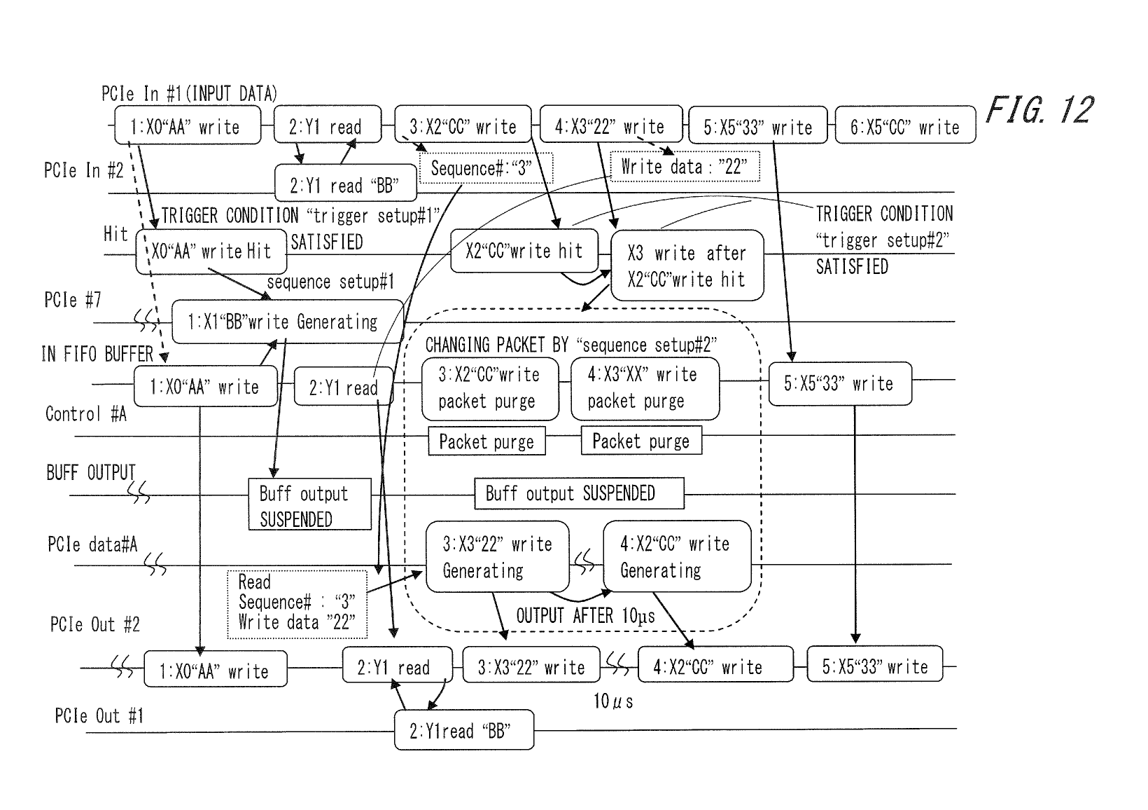

Next, a specific example of a process executed in the information processing apparatus 1 when the trigger condition and the sequences as illustrated in FIG. 4 are used is described below. FIG. 11 illustrates an example of a flowchart of processes executed in the information processing apparatus 1 in the present example. And FIG. 12 illustrates an example of a time chart when the information processing apparatus 1 executes the processes in FIG. 11. In the present embodiment, when the information processing apparatus 1 is powered on, the CPU #A 2a initiates the execution of the processes in FIG. 11.

It is assumed in the present example that the USB card 1h transfers data intermittently at the transfer speed of SuperSpeed (5.0 Gbps) and errors related to the intermittent transfer occur when an access to each of the X0, X2 and X3 registers occurs. The errors related to the intermittent transfer assumed here are errors in which, for example, a process for writing data in a register occurs, a delay of data transfer on a packet basis occurs in the buffer A 2h and therefore data cannot be transferred due to the mismatch between the timing at which data is output and the timing at which the intermittent data transfer is executed.

As illustrated in FIG. 12, the CPU #1 1a outputs sequences with sequence numbers 1 to 6 to the packet processing circuit ld. The sequence with the sequence number 1 is a sequence for writing data “AA” in the X0 register of the USB card 1h. In addition, the sequence with the sequence number 3 is a sequence for writing data “CC” in the X2 register of the USB card 1h. Further, the sequence with the sequence number 4 is a sequence for writing data “22” in the X3 register of the USB card 1h. It is assumed here that when the sequence with the sequence number 1 is executed or when the sequence with the sequence number 2 and the sequence with the sequence number 3 are executed, an error related to the intermittent transfer occurs due to the timings of accessing to the registers and the orders of accessing to the registers etc. and data cannot be transferred normally.

In the present example, when a sequence for writing data “AA” in the XO register of the USB card 1h in the sequence with the sequence number 1 occurs as illustrated in FIG. 12, the information processing apparatus 1 executes an additional sequence for writing data “BB” in the X1 register subsequent to the sequence with the sequence number 1. In addition, when a sequence for writing data “CC” in the X2 register in the sequence with the sequence number 3 occurs and then a sequence for writing data “XX” in the X3 register in the sequence with the sequence number 4 occurs as illustrated in FIG. 12, the information processing apparatus 1 executes the sequence for writing the data to the X3 register and then executes the sequence for writing the data to the X2 register after an interval equal to or longer than 10 82 sec.

In OP101, when the information processing apparatus 1 is powered on, the CPU #1 1a executes a boot loader stored in a BIOS ROM (not illustrated) in the information processing apparatus 1 to initiate the OS. In addition, the PCI configuration information stored in the flash memory #A 2d is notified to the CPU #1 1a in a sequence for executing a PCI configuration at the time of the booting. Further, the CPU #A 2a reads programs for executing processes stored in the area for initialization programs in the flash memory #A 2d and executes various initialization processes. Next, the process proceeds to OP102. In OP102, the CPU #A 2a reads programs for executing processes stored in the program area in the NVM #A 2c and executes the processes according to the programs. Further, the CPU #A 2a acquires data of trigger conditions and sequences from the USB memory 100 inserted into the USB slot 2b and uses the acquired data to generate a trigger/sequence table for the NVM #A 2c. It is assumed here that the trigger/sequence table is generated as illustrated in FIG. 4. Next, the process proceeds to OP103.

In OP103, the CPU #A 2a stores the trigger conditions stored in the NVM #A 2c in the comparison memory #N 3m, 3n of the packet monitoring circuit 2e. Specifically, the CPU #A 2a writes the data of the trigger condition “trigger setup#1” in the trigger/sequence table in FIG. 4 into the address 0 of the comparison memory #1 of the comparison memory #N 3m in the packet monitoring circuit 2e. The trigger condition “trigger setup#1” means a condition for determining whether a sequence output from the CPU #1 1a to the packet processing circuit 1d is a sequence for writing data “AA” in the XO register of the USB card 1h. In addition, the CPU #A 2a writes data of each condition included in the trigger condition “trigger setup#2” to the address in ascending order from the address 0 of the comparison memory #2. The trigger condition “trigger setup#2” includes a condition for determining whether a sequence output from the CPU #1 1a to the packet processing circuit 1d is a sequence for writing data “XX” (XX is an arbitrary number) in the X2 register of the USB card 1h. The trigger condition “trigger setup#2” further includes a condition for determining whether a sequence for writing data “CC” in the X3 register of the USB card 1h occurs subsequent to the sequence for writing data “XX” in the X2 register of the USB card 1h. Next, the process proceeds to OP104.

In OP104, the CPU #A 2a resets the address counters #N 3j, 3k of the packet monitoring circuit 2e and the address counters #N 4h, 4i of the access generating circuit 2f. In addition, the CPU #A 2a controls the multiplexer 5d of the buffer A 2h to select the input A1. Further, the CPU #A 2a controls the multiplexer 5d of the buffer B 2i to select the input A2. Next, the process proceeds to OP105.

In OP105, the CPU #A 2a determines whether a signal Hit-down#1 is input into the CPU #A 2a from the packet monitoring circuit 2e. As described above, the signal Hit-down#1 is a signal which indicates that the trigger condition “trigger setup#1” stored in the comparison memory #1 of the comparison memory #N 3m is satisfied. That is, the signal Hit-down#1 is a signal which indicates that a sequence output from the CPU #1 1a to the packet processing circuit 1d is a sequence for writing data “AA” in the X0 register of the USB card 1h. When the signal Hit-down#1 is input into the CPU #A 2a (OP105: Yes), the process proceeds to OP106. On the other hand, when the signal Hit-down#1 is not input into the CPU #A 2a (OP105: No), the process proceeds to OP107.

In OP106, the CPU #A 2a executes the sequence in the section “sequence setup#1” stored in the NVM #A 2c. As illustrated in FIG. 4, the sequence in the section “sequence setup#1” is a sequence for adding a process for writing data “BB” in the X1 register of the USB card 1h. The CPU #A 2a writes the sequence for writing data “BB” in the X1 register of the USB card 1h in the pattern generating memory #1 of the pattern generating memory #N 4f. The pattern generating memory #1 of the pattern generating memory #N 4f generates a PCIe packet including the sequence according to the information of sequence which is written in the pattern generating memory #1. The generated packet is output via the PCIe controller 2g from the packet processing circuit 1d. The packet output from the packet processing circuit 1d is transferred via the PCIe switch 1e to the USB card 1h. The USB card 1h executes the process for writing data “BB” in the X1 register according to the sequence as described above included in the transferred packet. The CPU #A 2a resets the address counter #1 of the address counter #N 3j and the address counter #1 of the address counter #N 4h. Next, the process proceeds to OP107.

In OP107, the CPU #A 2a determines whether a signal Hit-down#2 is input into the CPU #A 2a from the packet monitoring circuit 2e. As described above, the signal Hit-down#2 is a signal which indicates that the trigger condition “trigger setup#2” stored in the comparison memory #2 of the comparison memory #N 3m is satisfied. That is, the signal Hit-down#2 is a signal which indicates that a sequence output from the CPU #1 1a to the packet processing circuit 1d is a sequence for writing data “CC” in the X3 register of the USB card 1h which is executed subsequent to a sequence for writing data “XX” in the X2 register of the USB card 1h. When the signal Hit-down#2 is input into the CPU #A 2a (OP107: Yes), the process proceeds to OP108. On the other hand, when the signal Hit-down#2 is not input into the CPU #A 2a (OP107: No), the process returns to OP105.

In OP108, the CPU #A 2a executes the sequence in the section “sequence setup#2” stored in the NVM #A 2c. As illustrated in FIG. 4, the CPU #A 2a purges according to the sequence in the section “sequence setup#2” packets including a sequence for writing data in the X2 register of the USB card 1h and packets including a sequence for writing data in the X3 register of the USB card 1h among the packets stored in the FIFO multistage buffer #N of the buffer A 2h. Next, the CPU #A 2a reads the sequence number N of the sequence for writing data “CC” in the X2 register and the data “XX” to be written in the X3 register from the trace memory 3f of the packet monitoring circuit 2e. In the example in FIG. 12, since the sequence for writing data “CC” in the X2 register occurs as a sequence with the sequence number 3, N is 3. Further, since the sequence with the sequence number 4 is a sequence for writing data “22” in the X3 register, XX is 22.

Next, the CPU #A 2a uses the information read as described above to write the sequence with the sequence number 3 for writing data “22” in the X3 register of the USB card 1h in the address 0 in the pattern generating memory #2 of the pattern generating memory #N 4f. In addition, the CPU #A 2a writes the sequence with the sequence number N+1, namely 4 in this case, for writing data “CC” in the X2 register of the USB card 1h in the address 1 in the pattern generating memory #2 of the pattern generating memory #N 4f.

In addition, the CPU #A 2a controls the PCIe output controlling circuit 4e via the generation sequence controlling register #N 4j to suspend the outputting of packets by the FIFO multistage buffer #N 5b in the buffer A 2h. The outputting of packets is suspended for changing packets as described below. Further, the CPU #A 2a controls the multiplexer 5d to output packets input through the input A3.

Next, the CPU #A 2a controls the generation sequence controlling register #N 4j to execute the process which is written in the address 0 in the pattern generating memory #2 of the pattern generating memory #N 4f. As a result, the pattern generating memory #2 outputs a packet including the sequence for writing data “22” in the X3 register of the USB card 1h as a packet with the sequence number 3 via the serializer 4c and the multiplexer 5d to the packet processing circuit 1d.

Next, the CPU #A 2a wait for 10 μsec after the packet including the sequence for writing data “22” in the X3 register of the USB card 1h is output from the packet processing circuit 1d. And the CPU #A 2a controls the generation sequence controlling register #N 4j to execute the process which is written in the address 1 in the pattern generating memory #2 of the pattern generating memory #N 4f. As a result, the pattern generating memory #2 outputs a packet including the sequence for writing data “CC” in the X2 register of the USB card 1h as a packet with the sequence number 4 via the serializer 4c and the multiplexer 5d to the packet processing circuit 1d.

In addition, the CPU #A 2a resumes the processes for outputting the packets from the FIFO multistage buffer #N 5b in the buffer A 2h. And the CPU #A 2a controls the multiplexer 5d to output packets input from the input A1. As a result, as illustrated in FIG. 12, a packet including the sequence for writing data “33” in the X5 register in the USB card 1h which is input as a packet with the sequence number 5 into the packet processing circuit 1d from the CPU #1 1a is output as a packet with the sequence number 5 via the FIFO multistage buffer #N 5b and the multiplexer 5d from the packet processing circuit ld. In addition, the CPU #A 2a resets the address counter #2 of the address counters #N 3j of the packet monitoring circuit 2e. And the CPU #A 2a also resets the address counter #2 of the address counters #N 4h of the access generating circuit 2f.

As a result of the processes as described above, a packet including the sequence for writing data “CC” in the X2 register of the USB card 1h which is input as a packet with the sequence number 3 into the packet processing circuit 1d from the CPU #1 1a is output as a packet with the sequence number 4 from the packet processing circuit 1d. In addition, a packet including the sequence for writing data “22” in the X3 register of the USB card 1h which is input as a packet with the sequence number 4 into the packet processing circuit 1d from the CPU #1 1a is output as a packet with the sequence number 3 from the packet processing circuit 1d. Therefore, the order of the two packets is changed by the packet processing circuit 1d and the packets the order of which is changed are output to the USB card 1h.

When the CPU #A 2a completes the execution of the process in OP108, the process proceeds to OP109. In OP109, the CPU #A 2a determines whether a process for terminating the system of the information processing apparatus 1 occurs. When the process for terminating the system of the information processing apparatus 1 occurs (OP109: Yes), the CPU #A 2a terminates the processes of the flowchart. On the other hand, when the process for terminating the system of the information processing apparatus 1 does not occur (OP109: No), the process returns to OP105 and the processes as described above are repeated.

When the processes as described above are executed, the packet processing circuit 1d can detect whether a sequence included in a packet output from the CPU #1 1a satisfies a condition on which a failure occurs and can coordinate the order of sequences and the timing of the execution of the sequence according to the satisfied condition. The packet processing circuit 1d outputs the coordinated sequences to the hardware such as the USB card 1h as the destination of the packet. The processes for the packets in the downstream are described above. However, processes for packets in the upstream can be executed by units corresponding to the units which execute the processes for the packets in the downstream. Therefore, sequences for executing processes including changing of the order of accesses to the memory space and the I/O space for the hardware, changing of write data, deleting and/or adding of an access, and changing of the access timing etc. are registered in the packet processing circuit 1d in the present embodiment. Therefore, measures for preventing hardware failures can be administered in an integrated manner by the packet processing circuit 1d.

Although specific embodiments are described above, the configurations of the information processing apparatus 1 etc. described and illustrated in each example can be arbitrarily modified and/or combined. For example, it is assumed in the above embodiments that there are two trigger conditions and two sequences are executed when the trigger conditions are satisfied. However, the number of sequences is not limited to two. For example, when the third trigger condition and the third sequence are employed in the above embodiment, the information processing apparatus 1 can be configured to execute determination processes similar to the processes in OP105 and OP107 and processes similar to the processes in OP106 and OP108, subsequent to the process in OP108 in the above flowchart.

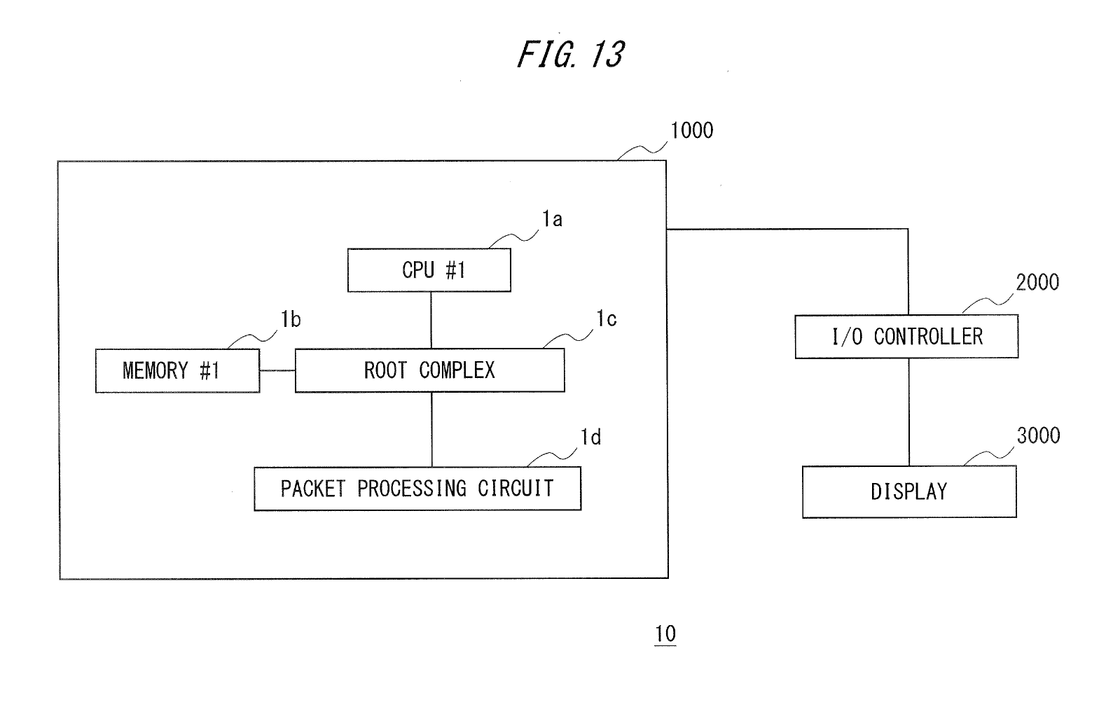

In addition, the above configuration of the information processing apparatus 1 and the above processes can be applied to the information processing system 10 according to a variation example described below. It is noted in the following descriptions that elements corresponding to the elements in the above embodiments are attached with the same symbols and the detailed descriptions for the elements are omitted. FIG. 13 schematically illustrates a configuration of the information processing system 10. As illustrated in FIG. 13, the information processing system 10 includes an information processing apparatus 1000, an I/O controller 2000 and a display 3000. In addition, the information processing apparatus 1000 includes a CPU #1 1a, memory #1 1b, a root complex 1c and a packet processing circuit 1d. In this variation example, the information processing apparatus 1000 is connected with the I/O controller 2000 via a PCIe cable. The I/O controller 200 corresponds to one of the peripheral devices in the above embodiments. The I/O controller 2000 controls the input and output of data to the display 3000 according to sequences input from the information processing apparatus 1000.

In this variation example, the CPU #1 1a outputs a sequence for controlling the I/O controller 2000. For example, it is assumed here that the sequence causes an error of the timing for inputting and outputting data to and from the I/O controller 2000. And noise appears on the screen of the display 3000 connected with the I/O controller 2000 due to the error. When a packet including the above sequence is input into the packet processing circuit 1d, the above processes are executed and the order of the sequences and the timing of the sequences are coordinated. As a result, the coordinated sequences are input into the I/O controller 2000. Therefore, the above failure can be prevented in the I/O controller 2000 and the noise is suppressed on the screen of the display 3000. It is noted that the peripheral devices connected with the information processing apparatus 1000 is not limited to the I/O controller 2000.

<<Computer Readable Recording Medium>>

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM. Further, a Solid State Drive (SSD) can be used as a recoding medium which is detachable from the computer or which is fixed to the computer.

According to one aspect, it is provided an information processing apparatus which prevents a failure without modifications of programs for the OS driver, the firmware and applications etc. used in the information processing apparatus.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
memory;
a processor configured to control a device; and
a circuit connected with the memory, the processor and the device and configured to:
store a first sequence which causes a failure of the device in a first storage area in the memory;
store a second sequence which prevents the failure in a second storage area in the memory;
determine whether a third sequence for controlling the device included in a packet output from the processor is the first sequence;
coordinate the third sequence by using the second sequence when the third sequence is the first sequence; and
generate a packet including the coordinated third sequence.

2. The information processing apparatus according to claim 1, wherein the second sequence includes at least one of a sequence for changing an order of access to memory space of the memory, a sequence for changing an order of access to Input/Output space of the memory, a sequence for changing data to be written to the device, a sequence for deleting an access to the device, a sequence for adding an access to the device, and a sequence for changing timing of an access to the device.

3. The information processing apparatus according to claim 1, wherein the circuit is configured to:
store a forth sequence which causes a failure of the device in the first storage area; and
execute a process for determining whether the third sequence is the first sequence and a process for determining whether the third sequence is the forth sequence in parallel.

4. The information processing apparatus according to claim 1, wherein the circuit is configured to:
repeat for a predetermined number of sequences a process for determining whether a fifth sequence output from the processor is a sequence stored in a first address of the first storage area and determining whether a sixth sequence output from the processor subsequent to the fifth sequence is a sequence stored in a second address of the first storage area.

5. The information processing apparatus according to claim 1, further comprising:
a plurality of buffers configured to store sequences output from the processor,
wherein the circuit is configured to:
control discarding the sequences stored in the plurality of buffers and selecting one of a sequence which is delayed via the plurality of buffers and the second sequence.

6. The information processing apparatus according to claim 5, wherein the circuit is configured to:
control the discarding and the selecting to execute at least one of a process for delaying a sequence output from the processor, a process for discarding a sequence output from the processor, a process for changing an order of a plurality of sequences output from the processor, a process for adding a sequence between a plurality of sequences output from the processor.

7. An information processing system, comprising:
an information processing apparatus; and
a device used by the information processing apparatus, wherein the information processing apparatus comprises:
memory;
a processor configured to control the device; and
a circuit connected with the memory, the processor and the device and configured to:
store a first sequence which causes a failure of the device in a first storage area in the memory;
store a second sequence which prevents the failure in a second storage area in the memory;
determine whether a third sequence for controlling the device included in a packet output from the processor is the first sequence;
coordinate the third sequence by using the second sequence when the third sequence is the first sequence; and
generate a packet including the coordinated third sequence.

8. The information processing system according to claim 7, wherein the second sequence includes at least one of a sequence for changing an order of access to memory space of the memory, a sequence for changing an order of access to Input/Output space of the memory, a sequence for changing data to be written to the device, a sequence for deleting an access to the device, a sequence for adding an access to the device, and a sequence for changing timing of an access to the device.

9. The information processing system according to claim 7, wherein the circuit is configured to:
store a forth sequence which causes a failure of the device in the first storage area; and
execute a process for determining whether the third sequence is the first sequence and a process for determining whether the third sequence is the forth sequence in parallel.

10. The information processing system according to claim 7, wherein the circuit is configured to:
repeat for a predetermined number of sequences a process for determining whether a fifth sequence output from the processor is a sequence stored in a first address of the first storage area and determining whether a sixth sequence output from the processor subsequent to the fifth sequence is a sequence stored in a second address of the first storage area.

11. The information processing system according to claim 7, wherein the information processing apparatus further comprises:
a plurality of buffers configured to store sequences output from the processor,
wherein the circuit is configured to:
control discarding the sequences stored in the plurality of buffers and selecting one of a sequence which is delayed via the plurality of buffers and the second sequence.

12. The information processing apparatus according to claim 11, wherein the circuit is configured to:
control the discarding and the selecting to execute at least one of a process for delaying a sequence output from the processor, a process for discarding a sequence output from the processor, a process for changing an order of a plurality of sequences output from the processor, a process for adding a sequence between a plurality of sequences output from the processor.

13. A non-transitory computer-readable recording medium storing a program that causes an information processing apparatus including memory, a device and a processor configured to control the device to:
store a first sequence which causes a failure of a device in a first storage area in the memory;
store a second sequence which prevents the failure in a second storage area in the memory;
determine whether a third sequence for controlling the device included in a packet output from the processor is the first sequence;
coordinate the third sequence by using the second sequence when the third sequence is the first sequence; and
generate a packet including the coordinated third sequence.

14. The non-transitory computer-readable recording medium according to claim 13, wherein the second sequence includes at least one of a sequence for changing an order of access to memory space of the memory, a sequence for changing an order of access to Input/Output space of the memory, a sequence for changing data to be written to the device, a sequence for deleting an access to the device, a sequence for adding an access to the device, and a sequence for changing timing of an access to the device.

15. The non-transitory computer-readable recording medium according to claim 13, wherein the program causes the information processing apparatus to:
store a forth sequence which causes a failure of the device in the first storage area; and
execute a process for determining whether the third sequence is the first sequence and a process for determining whether the third sequence is the forth sequence in parallel.

16. The non-transitory computer-readable recording medium according to claim 13, wherein the program causes the information processing apparatus to:
repeat for a predetermined number of sequences a process for determining whether a fifth sequence output from the processor is a sequence stored in a first address of the first storage area and determining whether a sixth sequence output from the processor subsequent to the fifth sequence is a sequence stored in a second address of the first storage area.

17. The non-transitory computer-readable recording medium according to claim 13, wherein the information processing apparatus further comprises:
a plurality of buffers configured to store sequences output from the processor,
wherein the program causes the information processing apparatus to:
control discarding the sequences stored in the plurality of buffers and selecting one of a sequence which is delayed via the plurality of buffers and the second sequence.

18. The non-transitory computer-readable recording medium according to claim 17, wherein the program causes the information processing apparatus to:
control the discarding and the selecting to execute at least one of a process for delaying a sequence output from the processor, a process for discarding a sequence output from the processor, a process for changing an order of a plurality of sequences output from the processor, a process for adding a sequence between a plurality of sequences output from the processor.
